(19) United States
(12) Patent Application Publication
(10) Pub. No.: US 2010/0036796 A1
(43) Pub. Date: Feb. 11, 2010

(54) IMAGE FORMING APPARATUS, LOG STORING METHOD, AND COMPUTER PROGRAM PRODUCT

(76) Inventors: Takeshi KAJIKAWA, Tokyo (JP); Yoshiharu TOJO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/504,082

(22) Filed: Jul. 16, 2009

(30) Foreign Application Priority Data
Aug. 8, 2008 (JP) 2008-205161
Jun. 23, 2009 (JP) 2009-148641

(51) Int. Cl. G06N 7/04; G06F 17/30

(52) U.S. Cl. 706/54; 707/104.1; 707/100; 707/E17.032; 707/E17.007; 707/E17.044; 707/204

(57) ABSTRACT

A ticket generating unit generates, for a processing request received from a user and an entity containing a series of processes to be executed based on the processing request, a ticket containing request identification information for identifying the processing request and user information for identifying the user. An execution processing unit executes, upon receiving the processing request and the ticket, requested processing according to the entity. A log managing unit records log information related to the processing executed by the execution processing unit, in a log storing unit in a reduced manner.

### CROSS-REFERENCE TO RELATED APPLICATIONS

The present application claims priority to and incorporates by reference the entire contents of Japanese Patent Application No. 2008-205161 filed in Japan on Aug. 8, 2008 and Japanese Patent Application No. 2009-148641 filed in Japan on Jun. 23, 2009.

### BACKGROUND OF THE INVENTION

1. Field of the Invention

The present invention relates to a technology for storing log information as a history of events in an image forming apparatus.

2. Description of the Related Art

In recent years, an image forming apparatus such as a multifunction peripheral (MFP) has been used by being connected to a network such as the Internet or a local area network (LAN) so that the image forming apparatus can be accessed by a client and the like on the same network. Such an image forming apparatus is configured to store log information such as a security log or a job log to ensure security thereof or to enable research of usage or the like (see, for example, Japanese Patent Application Laid-open No. H11-136428, Japanese Patent Application Laid-open No. 2004-151994, and Japanese Patent Application Laid-open No. 2006-107217). Meanwhile, in recent years, the image forming apparatus has been formed of a platform unit and an application unit that works on the platform unit. With this configuration, users or third persons, such as third vendors, of the image forming apparatus are allowed to develop a new external application such as an application used for image processing and install the new external application in the image forming apparatus, so that the new external application can be activated on the platform unit.

However, when one processing request is issued to a predetermined application (e.g., when an operation button for executing predetermined processing is pressed once by a user), there may be a case where a large number of processing requests are issued from the application to the platform unit. In this case, a large amount of log information is created as a result of execution of the processing according to a large number of the processing requests. For example, when a processing request for a data access using batch processing, such as an export of 1000 items of initial settings or an import of 500 pieces of address book data with respect to a single processing request, is issued from the user, a log is recorded with respect to each item or each data, so that a large amount of log information is created. If the large amount of the log information is created, a memory area for the log information may become full with the log information, so that the memory area for recording new log information may not be assured. Furthermore, if the log information is transferred to an external apparatus, load on a communication path increases because of transfer of the large amount of the log information.

### SUMMARY OF THE INVENTION

It is an object of the present invention to at least partially solve the problems in the conventional technology.

According to one aspect of the present invention, there is provided an image forming apparatus including a log storing unit that stores therein log information as a history of events in the image forming apparatus; a receiving unit that receives a predetermined processing request from a user; a ticket generating unit that generates, for a processing request received from the user and an entity containing a series of processes to be executed based on the processing request, a ticket containing request identification information for identifying the processing request and user information for identifying the user; an execution processing unit that executes, upon receiving the processing request and the ticket, requested processing according to the entity; and a log managing unit that records first log information, which is the log information related to the processing executed by the execution processing unit, in the log storing unit in a reduced manner.

Furthermore, according to another aspect of the present invention, there is provided a log storing method in an image forming apparatus including a log storing unit that stores therein log information as a history of events in the image forming apparatus. The log storing method includes receiving a predetermined processing request from a user; generating, for a processing request received from the user and an entity containing a series of processes to be executed based on the processing request, a ticket containing request identification information for identifying the processing request and user information for identifying the user; executing, upon receiving the processing request and the ticket, requested processing according to the entity; and recording log information related to the processing executed at the executing in the log storing unit in a reduced manner.

Moreover, according to still another aspect of the present invention, there is provided a computer program product including a computer-usable medium having computer-readable program codes embodied in the medium for storing a log in an image forming apparatus including a log storing unit that stores therein log information as a history of events in the image forming apparatus. The program codes when executed cause a computer to execute receiving a predetermined processing request from a user; generating, for a processing request received from the user and an entity containing a series of processes to be executed based on the processing request, a ticket containing request identification information for identifying the processing request and user information for identifying the user; executing, upon receiving the processing request and the ticket, requested processing according to the entity; and recording log information related to the processing executed at the executing in the log storing unit in a reduced manner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a functional configuration of a multifunction peripheral (MFP) according to a first embodiment of the present invention;

FIG. 2 is a schematic diagram illustrating an example of a security log;

FIG. 3 is a schematic diagram illustrating an example of the security log recorded based on a recording pattern A;

FIG. 4 is a schematic diagram illustrating an example of the security log recorded based on a recording pattern B;

FIG. 5 is a schematic diagram illustrating an example of the security log recorded based on a recording pattern C;

FIG. 6 is an example of contents of a recording-pattern set table;

FIG. 7 is a schematic diagram illustrating an example of a ticket;

FIG. 8 is an example of contents of a log-omission determination table;

FIG. 9 is a sequence diagram of a process for storing a security log by the MFP according to the first embodiment;

FIG. 10 is a sequence diagram of a process for storing the security log by the MFP according to the first embodiment;

FIG. 11 is a sequence diagram of a process for storing the security log by the MFP according to the first embodiment;

FIG. 12 is a flowchart of a process for recording the security log;

FIG. 13 is a schematic diagram illustrating an example of an image forming system according to a second embodiment of the present invention;

FIG. 14 is a block diagram of configurations of an MFP and a log collection server shown in FIG. 13;

FIG. 15 is a schematic diagram illustrating an example of a print log created when print data of a first sheet is printed;

FIG. 16 is a schematic diagram illustrating an example of a print log created when print data of a second sheet is printed;

FIG. 17 is a schematic diagram of another example of a print log created when the print data of the second sheet is printed;

FIG. 18 is a sequence diagram of a process for storing a print log by the MFP shown in FIG. 13;

FIG. 19 is a flowchart of a process for recording the print log by the MFP shown in FIG. 13; and

FIG. 20 is a block diagram of a hardware configuration of the MFP according to the first and the second embodiments.

### DETAILED DESCRIPTION OF THE PREFERRED EMBODIMENTS

Exemplary embodiments of the present invention are explained in detail below with reference to the accompanying drawings. In the following embodiments, an example is used in which an image forming apparatus according to the present invention is applied to a multifunction peripheral (MFP) having at least two functions among a copy function, a printer function, a scanner function, and a facsimile (FAX) function. However, the present invention can also be applied to other image forming apparatuses such as a copier, a printer, a scanner, and a FAX machine.

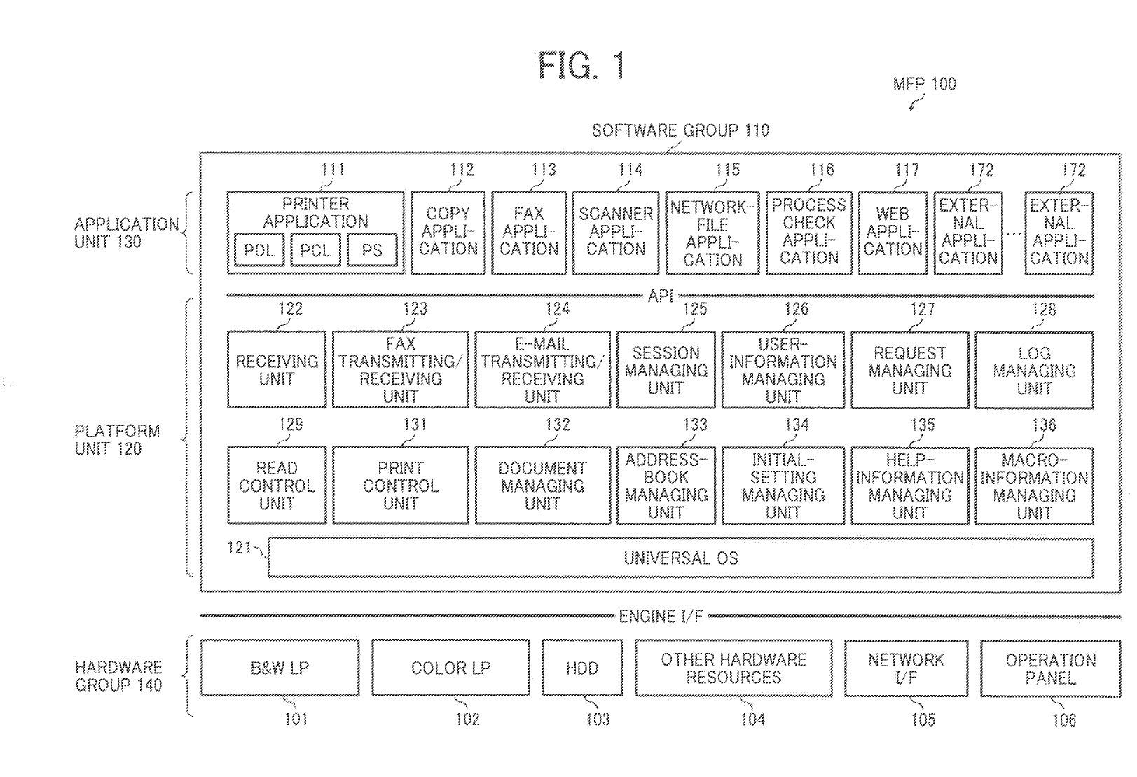

FIG. 1 is a block diagram of a functional configuration of an MFP 100 according to a first embodiment of the present invention. The MFP 100 includes a hardware group 140 that includes a black and white laser printer (B&W LP) 101, a color laser printer (color LP) 102, a hard disk drive (HDD) 103, a hardware resource 104 such as a scanner, a FAX, and a memory, a network interface (I/F) 105 that performs an input-output control with respect to an external apparatus, and an operation panel 106. The MFP 100 also includes a software group 110 that includes an application unit 130 and a platform unit 120. The application unit 130 performs processing related to image formation. The platform unit 120 controls the hardware group 140 according to a request received from the application unit 130.

The MFP 100 records a security log that is a log related to security of the MFP 100, as one of pieces of log information as a history of events that have occurred in the MFP 100. The MFP 100 is configured to omit recording of redundant logs and unnecessary logs when recording the security log.

Specifically, the security log is a log related to security of the MFP 100 and stored for use by a system administrator (an administrator of the MFP 100). The security log is used for checking, at a later date, whether unauthorized activities have been attempted or succeeded in the MFP 100, or for preventing third persons from committing unauthorized activities on the MFP 100 by notifying the third persons of the fact that the security log is recorded. Because of such characteristics of the security log, therefore, access to the security log is controlled such that even a user who has recorded the security log is not allowed to rewrite or delete the security log.

In the MFP 100, it is effective to record the security log from the platform unit 120. The reason for this is that if an application is forced to store log information such as the security log, development of the application may be burdened, leading to interruption of the development. Furthermore, by storing the log information from the platform unit 120, problems such as failure to store some pieces of the log information or missing of some pieces of the log information can be prevented.

Meanwhile, to achieve various functions with external applications, it is preferable to provide an application program interface (APT) having the simplest structure possible in the platform unit 120. For example, assuming that the platform unit 120 is provided with only an API capable of acquiring addresses started from “A”, “B”, . . . , and “Z” in bulk, and when an address is to be extracted from an address book, even if only one specific address is to be extracted or only a predetermined number, e.g., thirty, of arbitrary addresses listed up by an application are to be extracted, the API always acquires the addresses started from “A”, “B”, . . . , and “Z” in bulk at the first processing stage. Therefore, it is necessary to subsequently perform processing for extracting an address corresponding to a request from the addresses acquired by the application. As a result, access count to the address book increases and processing may be performed redundantly, resulting in decreased performance. In view of this, in the first embodiment, the platform unit 120 is provided with not only an API function for acquiring the addresses started from “A”, “B”, . . . , and “Z” in bulk but also a simple API function for making a request to acquire a single address. Thus, the platform unit 120 can support various procedures for acquiring addresses.

When a user sends a single processing request to the application, the application issues an API function to send the processing request to the platform unit 120. At this time, because the API of the platform unit 120 includes a simple API for making a request to acquire a single address, a large number of API functions may be issued in response to the single processing request from the user. Accordingly, the security log is recorded with respect to each issued API function, so that a large number of the security logs are created. For example, as described above, when a processing request for a data access using batch processing, such as an export of 1000 items of initial settings or an import of 500 pieces of address book data with respect to a single processing request, is issued from the user, an API function is issued with respect to each item or each data and a log is recorded with respect to each API function, so that a large number of the security logs are created. If a large number of the security logs are created, a memory area for the security logs may be occupied, so that the memory area for recording a new security log may not be assured. Therefore, there is a demand for omitting recording of some items of the security log when recording the security log.

The MFP 100 is configured to enable recording of the security log from the platform unit 120 provided with the API having a simple structure. Furthermore, the MFP 100 is configured to enable storing, even when a large number of the security logs are recorded, of the security log with a reduced size by omitting recording of redundant logs and unnecessary logs when recording the security log. A method for storing the security log with the reduced size by the MFP 100 is described in detail below.

The HDD 103 is a recording medium for storing log information such as the security log or a print log created through printing, various tables, and document information. The operation panel 106 is configured to display various screens for a user and assist the user to input an instruction via the displayed screens and an operation key.

The application unit 130 is described in detail below. The application unit 130 includes a printer application 111 as an application for a printer and employing a page description language (PDL), a printer command language (PCL), and a post script (PS), a copy application 112 as an application for a copier, a FAX application 113 as an application for a FAX machine, a scanner application 114 as an application for a scanner, a network-file application 115 as an application for a network file, a process check application 116 as an application for checking a process, and a WEB application 117 that functions as an WEB server (i.e., an http server) with respect to a client terminal such as a personal computer (PC) connected to the Internet and displays various screens on a WEB browser that works on the client terminal.

The application unit 130 and the platform unit 120 realize user services for image forming processing, such as a copier, a printer, a scanner, and a FAX machine, through communication with each other through function call, transmission of a return value from the function, transmission and reception of a message, and the like.

The MFP 100 allows third persons such as a customer or a third vendor of the MFP 100 to develop and install external applications 172 in an application layer on a control service layer.

The platform unit 120 is explained in detail below. The platform unit 120 mainly includes a universal operating system (OS) 121, a receiving unit 122 that operates on the universal OS 121, a FAX transmitting-receiving unit 123, an e-mail transmitting-receiving unit 124, a session managing unit 125, a user-information managing unit 126, a request managing unit 127, a log managing unit 128, a read control unit 129, a print control unit 131, a document managing unit 132, an address-book managing unit 133, an initial-setting managing unit 134, a help-information managing unit 135, and a macro-information managing unit 136.

The universal OS 121 is a universal operating system such as UNIX (registered trademark), and executes software of the platform unit 120 and software of the application unit 130 in parallel as processes.

The receiving unit 122 receives a login request, a predetermined processing request, and the like from a user via the operation panel 106. The predetermined processing is, for example, copying, FAX transmission, and e-mail transmission and reception executed by an application. A series of processes is executed in response to a single processing request received from the user. For example, if the user once presses an operation button for performing a copy process, the MFP 100 causes the copy application 112 and the units of the platform unit 120 to perform a series of processes for conveying an original, reading an image of the original, outputting the read image onto a recording medium such as a sheet, and outputting the sheet.

The receiving unit 122 also receives a setting of a recording pattern, in which a log item to be omitted when recording the security log is set with respect to each type of information to be subjected to predetermined processing (hereinafter, “operation target information”) and an operation type of the operation target information. The recording pattern can be set, for example, by a system administrator of the MFP 100. The receiving unit 122 also receives, when the security log is recorded, a setting of an attribute of the operation target information, which is added with respect to each type of the operation target information.

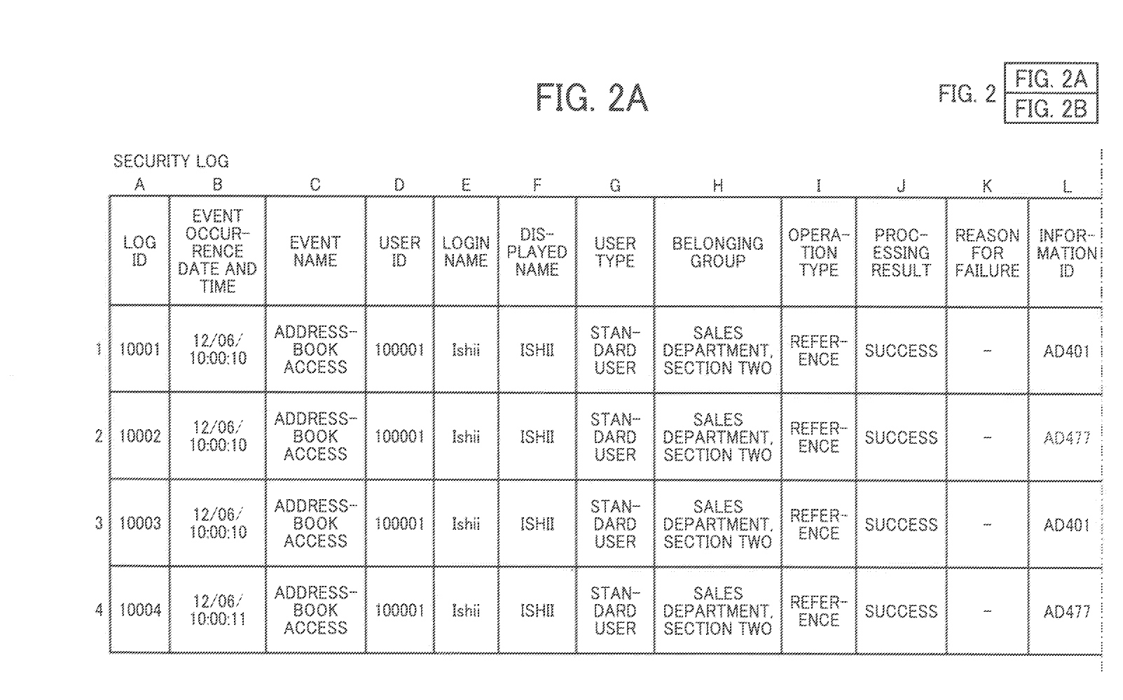

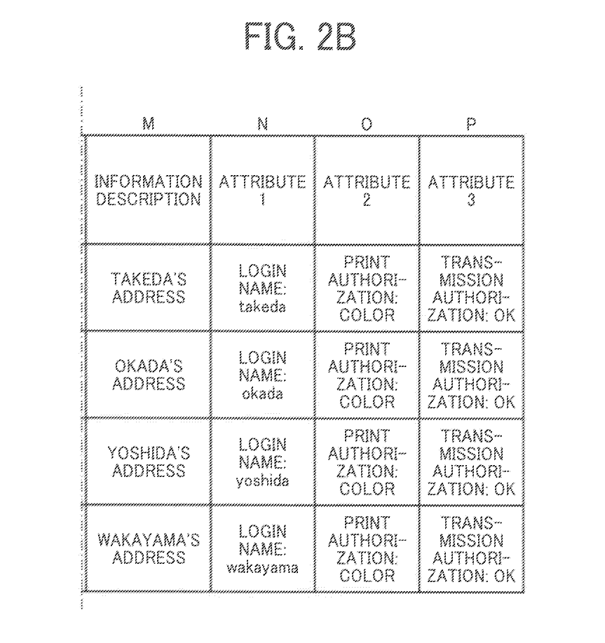

The security log and the recording pattern are described in detail below. FIG. 2 is a schematic diagram illustrating an example of the security log. The security log contains items such as an event occurrence date and time, information about a user who has performed an operation (i.e., user information), and processing contents recorded when any events have occurred in the MFP 100.

More particularly, as shown in FIG. 2, the security log contains (A) a log ID for identifying a log, (B) an event occurrence date and time, (C) an event name, (D) to (H) information related to a user (i.e., (D) a user ID for identifying the user, (E) a login name of the user, (F) a displayed name of the user, (G) a user type as a type of the user, and (H) a belonging group of the user), (I) an operation type of the operation target information, (J) a processing result, (K) a reason for failure when the processing has failed, and (L) to (P) information related to the operation target information (i.e., (L) an information ID for identifying the operation target information, (M) information description by which information can be easily identified by a user, and (N) attribute 1, (O) attribute 2, (P) attribute 3 of the information for indicating detailed contents of the information).

In this manner, the security log shown in FIG. 2 contains all logs for all events that have occurred. However, in some cases, some recorded logs may be redundant or may not be indispensable. More particularly, the information related to the user (i.e., (D) to (H)) contains redundant information because the logs are created based on a request made by a single user. Therefore, if it is clearly confirmed that logs on the first to the fourth rows are created based on a single processing request made by the single user, the redundant logs need not be recorded. Furthermore, the information related to the operation target information (i.e., (L) to (P)) is, while it does not contain redundant logs, recorded only for providing detailed information related to the processing. Therefore, the information may contain items that are not necessarily recorded to prevent increase in size of the security log. Thus, the recording pattern indicates log items that can be omitted such as redundant logs and unnecessary logs. In the first embodiment, the MFP 100 records the security log based on one of recording patterns A to D set in advance.

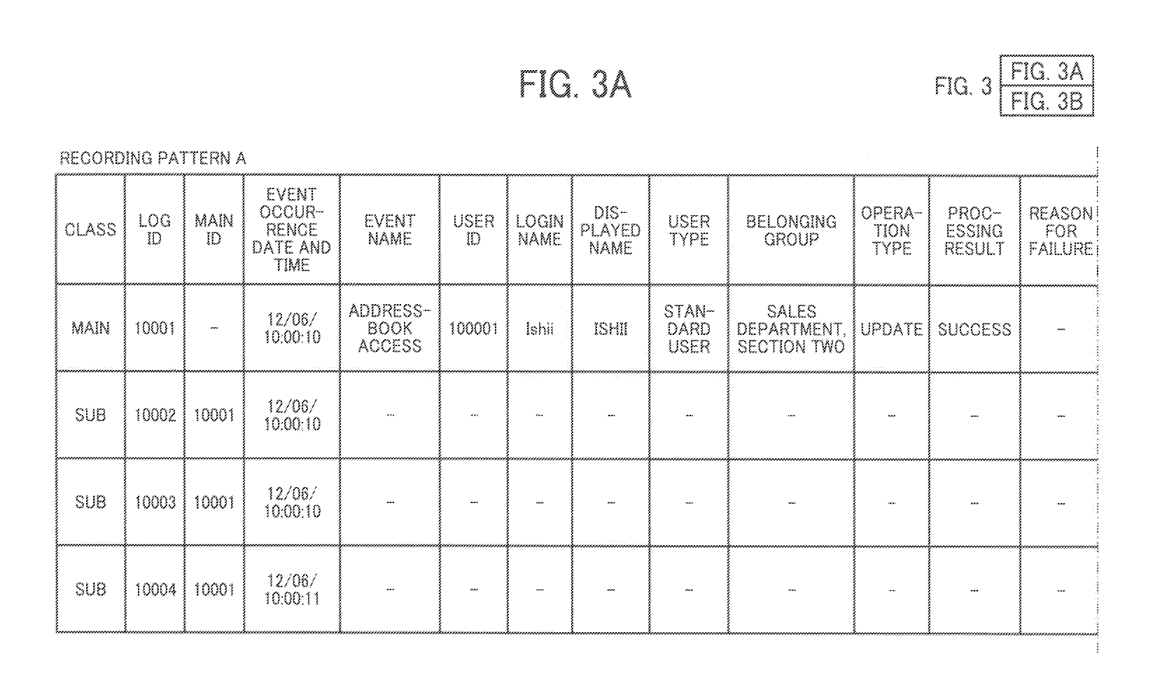

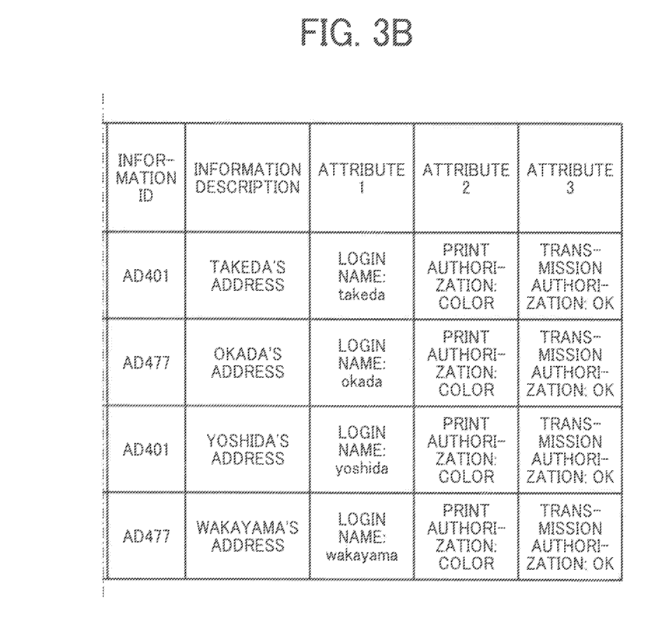

The recording pattern A is described in detail below. FIG. 3 is a schematic diagram illustrating an example of the security log recorded based on the recording pattern A. The recording pattern A is structured such that, in a log created according to a single processing request received from a user, the information related to the user who has sent the processing request is redundant and can be shared, the log corresponding to the information related to the user is recorded at only the first recording, and is omitted at the second or later recording. The recording pattern A is also structured such that logs corresponding to the information related to the operation target information, such as the information ID, the description of the information, and the attributes 1 to 3, are recorded.

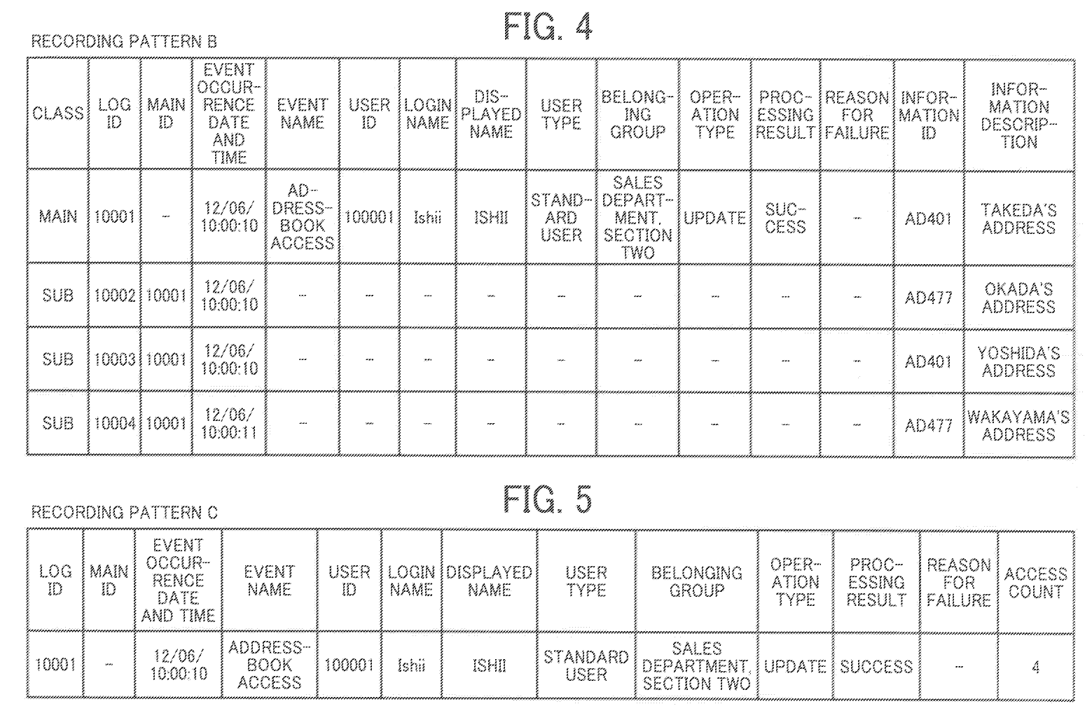

The recording pattern B is described in detail below. FIG. 4 is a schematic diagram illustrating an example of the security log recorded based on the recording pattern B. The recording pattern B is structured such that, similar to the recording pattern A, in a log created according to a single processing request received from a user, the log corresponding to the information related to the user is recorded for only the first event, and is omitted for the second or later event. The recording pattern B is also structured such that among logs corresponding to the information related to the operation target information, only the information ID and the description of the information are recorded and the attributes 1 to 3 are not recorded.

The recording pattern C is described in detail below. FIG. 5 is a schematic diagram illustrating an example of the security log recorded based on the recording pattern C. The recording pattern C is structured such that, in a log created according to a single processing request received from a user, logs corresponding to the information related to the operation target information are not recorded, and only access count to the operation target information is recorded. The recording pattern D is structured such that the security log is not recorded.

Upon receiving a setting of one of the recording patterns (the recording patterns A to D) from a user, the receiving unit 122 registers the setting in a recording-pattern set table. The recording-pattern set table is a table for registering a recording pattern set with respect to each type of the operation target information to be subjected to predetermined processing and each operation type of the operation target information. The recording-pattern set table is written by an extensible markup language (XML) or a text file, and stored in a storage unit (not shown). The recording-pattern set table also contains an attribute of the operation target information, which is set by the user and to be added to the security log, with respect to each type of the operation target information.

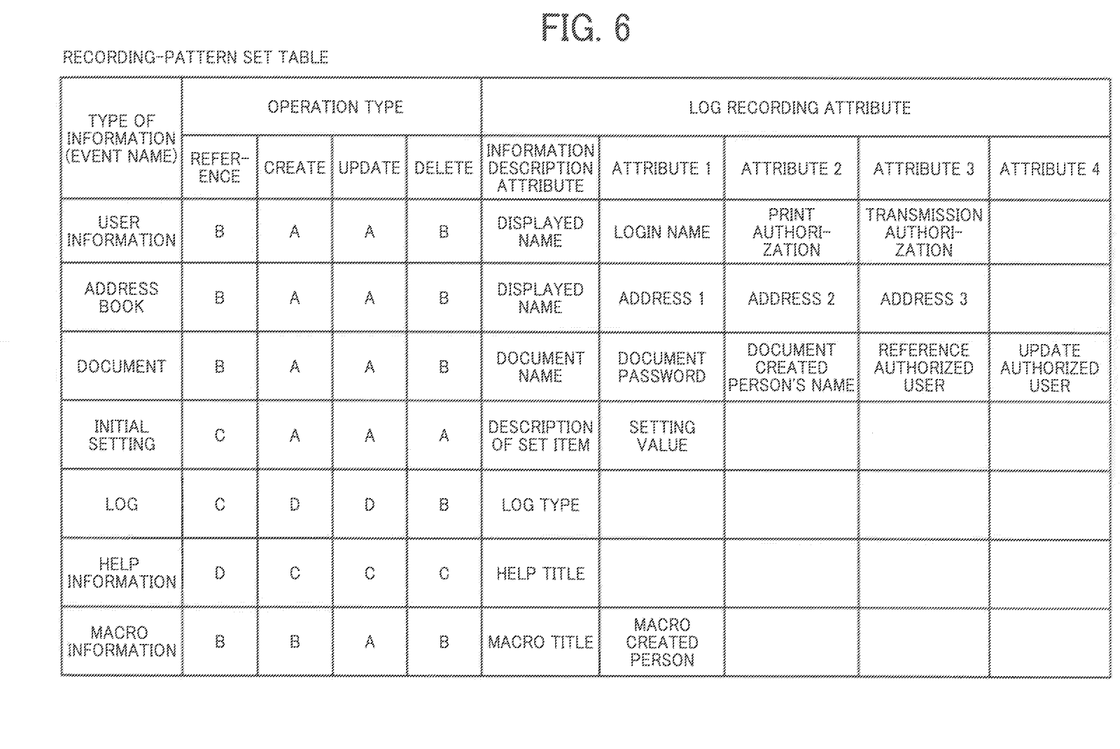

FIG. 6 is a schematic diagram illustrating an example of the recording-pattern set table. In the recording-pattern set table, recording patterns are registered with respect to each type of the operation target information, such as “user information” and “address book”, and each operation type of the operation target information, such as “reference” and “create”. Furthermore, in the recording-pattern set table, attributes of the operation target information, such as “description of information” and “attribute 1”, to be added to the security log are registered with respect to each type of the operation target information.

Returning to FIG. 1, the FAX transmitting-receiving unit 123 controls transmission and reception of FAX data. The e-mail transmitting-receiving unit 124 controls transmission and reception of an e-mail.

The session managing unit 125 acquires, upon receiving a login request that has been made by a user from the receiving unit 122, user information as information for identifying the user from the user-information managing unit 126, performs user authentication, and notifies the receiving unit 122 of a login result and session information. The session information contains information related to the user who has logged in as a result of success in the user authentication (i.e., user information) and attribute information of login processing.

Upon receiving, from the receiving unit 122, a predetermined processing request made by the user, the session managing unit 125 generates one ticket for one entity containing a single processing request received from the user and a series of processes to be executed based on the single processing request. The ticket contains a request ID used for identifying the processing request and issued by the session managing unit 125 and the user information for identifying the user who has sent the processing request. When the application sends the ticket and a request for various processing to the platform unit 120, the platform unit 120 can identify that, based on the request ID, the request received from the application is made according to the single processing request sent by the user. The session managing unit 125 invalidates the ticket when the requested processing is completed.

In the conventional image forming apparatus, predetermined processing such as printing is performed based on a ticket generated for each job such as a print job. On the other hand, the MFP 100 performs predetermined processing such as printing based on a ticket generated for each entity. Therefore, the security log is stored for each entity. For example, if a process for referring to two addresses is performed based on a single processing request made by a user, only one security log is stored. On the other hand, if a process for referring to one address is performed twice each based on a single processing request made by a user, that is, if the processes for referring to two addresses are performed based on two processing requests made by the user, two security logs are stored.

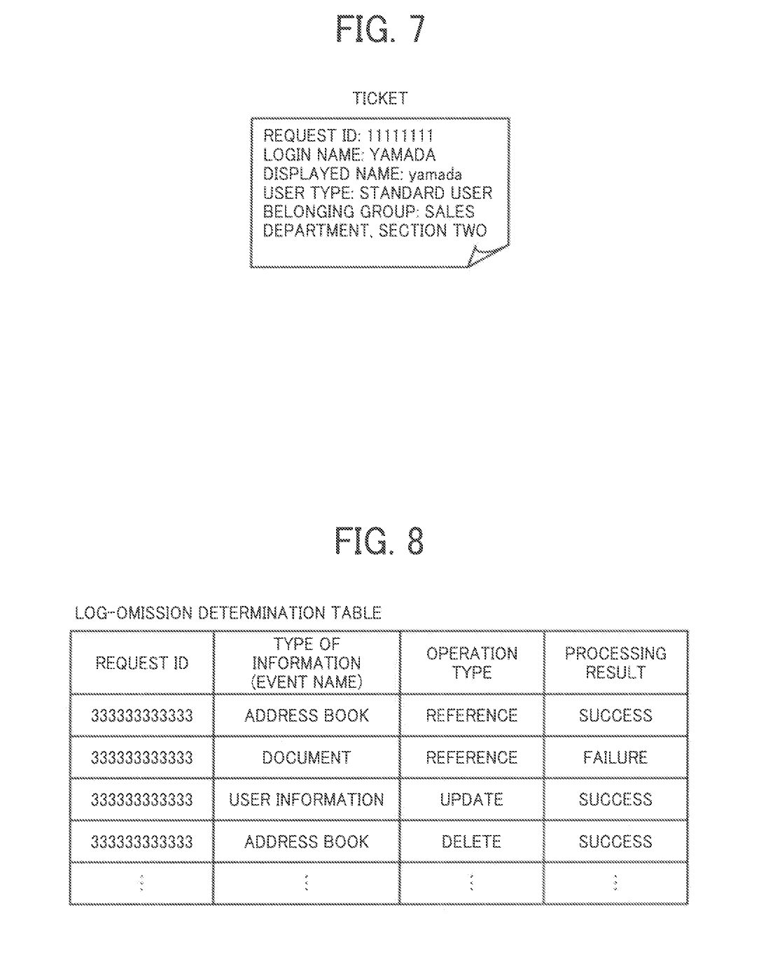

FIG. 7 is a schematic diagram illustrating an example of the ticket. The ticket contains a request ID “11111111”, and the user information such as a login name “yamada”, a displayed name “yamada”, a user type “standard user”, and a belonging group “sales department, section two”.

Returning to FIG. 1, the user-information managing unit 126 manages the user information. Upon receiving a request for acquiring the user information from the session managing unit 125, the user-information managing unit 126 sends the user information to the session managing unit 125.

The request managing unit 127 authorizes execution of the processing request and manages a processing sequence. More particularly, the request managing unit 127 receives the processing request from the application, causes the session managing unit 125 to generate a ticket for one entity according to one received processing request, and sends the generated ticket to the application. When the processing is completed, the request managing unit 127 causes the session managing unit 125 to invalidate the generated ticket.

The log managing unit 128 manages a log. The log managing unit 128 also records the security log related to processing, which has been performed by execution processing units (e.g., the document managing unit 132 and the print control unit 131) that are modules of the platform unit 120 according to a single processing request, with respect to each processing request indicated by the ticket acquired from the application, and with omission of recording of logs for some items based on the recording pattern set in the recording-pattern set table.

For example, when the recording pattern A is set, the log managing unit 128 records, with respect to each processing request indicated by the ticket and according to a single processing request, all security logs in the HDD 103 at the first recording, and omits recording of logs containing redundant contents, i.e., logs corresponding to the information related to the user while recording the security log in the HDD 103 at the second or later recording. The log managing unit 128 records the security log in the HDD 103 while adding the attribute set in the recording-pattern set table to the security log (see FIG. 3).

When the recording pattern B is set, the log managing unit 128 records, with respect to each processing request indicated by the ticket and according to a single processing request, all security logs in the HDD 103 at the first recording, and omits recording of logs containing redundant contents, i.e., logs corresponding to the information related to the user while recording the security log in the HDD 103 at the second or later recording. The log managing unit 128 omits recording of the attributes 1 to 3 of the operation target information when recording the security log in the HDD 103 (see FIG. 4).

When the recording pattern C is set, the log managing unit 128 records, as the security log, only the access count to the operation target information in the HDD 103, with respect to each processing request indicated by the ticket and according to a single processing request (see FIG. 5). When the recording pattern D is set, the log managing unit 128 does not record the security log.

When recording the security log based on the set recording pattern, the log managing unit 128 temporarily stores and manages a log-omission determination table for determining a relation among security-log recording requests made by a plurality of number of times. FIG. 8 is a schematic diagram illustrating an example of the log-omission determination table. The log-omission determination table is updated every time predetermined processing is executed and a log is generated. As shown in FIG. 8, the log-omission determination table contains a request ID of a processing request, such as “333333333333”, a type of the operation target information, such as “address book” or “user information”, an operation type of the operation target information, such as “reference” or “update”, and a processing result, such as “success” or “failure”, in an associated manner.

The log managing unit 128 determines, when recording the security log, whether the created security log is contained in the log-omission determination table. When the security log is contained in the log-omission determination table, the log managing unit 128 determines that the security log is created based on the second or later processing request. On the other hand, when the security log is not contained in the log-omission determination table, the log managing unit 128 determines that the security log is created based on the first processing request, and adds information about the security log to the log-omission determination table. The log-omission determination table can be structured to store a predetermined number of logs at maximum in such a manner that the oldest log is overwritten with the latest log when the predetermined number of logs are already stored and a new log is to be stored. The reason why the processing result is contained in the log-omission determination table is that the security log created when the processing has succeeded and the security log created when the processing has failed can be recorded independent of each other in consideration of a case where the security log crated when the processing has failed needs to be examined.

Upon receiving a read processing request together with the ticket from the application such as the copy application 112 and the scanner application 114, the read control unit 129 controls the scanner to execute read processing. Upon receiving a print request together with the ticket from the application such as the copy application 112, the print control unit 131 controls the printer to execute printing.

The document managing unit 132 manages documents stored in the HDD 103, and executes the requested processing upon receiving a processing request together with the ticket from the application. The address-book managing unit 133 manages address information as a communication destination, and executes the requested processing upon receiving a processing request together with the ticket from the application. The initial-setting managing unit 134 manages an initial setting, and executes the requested processing upon receiving a processing request together with the ticket from the application. The help-information managing unit 135 manages help information, and executes the requested processing upon receiving a processing request together with the ticket from the application. The macro-information managing unit 136 manages macro information, and executes the requested processing upon receiving a processing request together with the ticket from the application.

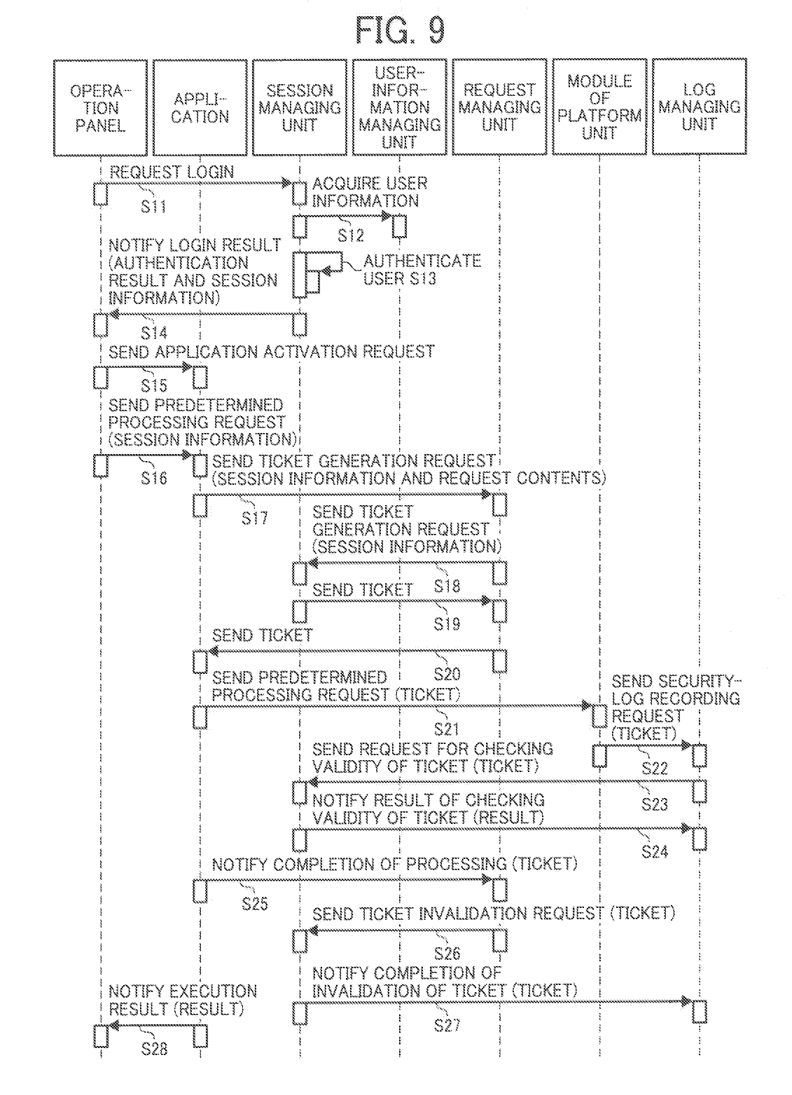

A process for storing the security log by the MFP 100 configured as described above is described in detail below. FIG. 9 is a sequence diagram of the process for storing the security log by the MFP 100. In the example shown in FIG. 9, the process for storing the security log performed when any one of the execution processing units (e.g., the document managing unit 132 or the print control unit 131) of the platform unit 120 executes predetermined processing is explained.

Upon receiving a login request from a user via the operation panel 106, the receiving unit 122 sends the received request to the session managing unit 125 (Step S11). Upon receiving the login request, the session managing unit 125 acquires user information from the user-information managing unit 126 (Step S12), performs user authentication for the user who has sent the login request (Step S13), and outputs an authentication result and session information to notify the receiving unit 122 of a login result (Step S14).

Upon receiving a predetermined processing request from the user who has logged in as a result of user authentication success via the operation panel 106, the receiving unit 122 sends an activation request for activating an application corresponding to the predetermined processing (Step S15), and sends the predetermined processing request to the activated application (Step S16).

Upon receiving the predetermined processing request, the application sends the session information and requested contents to the request managing unit 127, and sends a ticket generation request for one entity according to the processing request to the request managing unit 127 (Step S17). Upon receiving the ticket generation request, the request managing unit 127 sends the ticket generation request to the session managing unit 125 (Step S18).

Upon receiving the ticket generation request, the session managing unit 125 generates a ticket corresponding to the one processing request sent by the user, and sends the ticket to the request managing unit 127 (Step S19). At this time, the session managing unit 125 checks validity of the session information. Then, the request managing unit 127 sends the ticket to the application that has issued the processing request (Step S20).

Upon acquiring the ticket, the application sends a predetermined processing request together with the ticket to the execution processing unit that functions as a module of the platform unit 120 and performs the predetermined processing (Step S21). The execution processing unit executes the processing based on the processing request, and sends a security-log recording request together with the ticket to the log managing unit 128 (Step S22).

The log managing unit 128 sends a check request for checking validity of the acquired ticket to the session managing unit 125 (Step S23). The session managing unit 125 checks the validity of the ticket and sends a result of checking the validity of the ticket to the log managing unit 128 (Step S24). When the ticket is valid, the log managing unit 128 records a security log in the HDD 103 based on the recording pattern set in the recording-pattern set table.

When the predetermined processing based on the processing request is completed, the application notifies the request managing unit 127 of a completion of the processing corresponding to the processing request, together with the ticket (Step S25). The request managing unit 127 sends an invalidation request for invalidating the ticket to the session managing unit 125 (Step S26).

Upon receiving the invalidation request, the session managing unit 125 invalidates the ticket and notifies the log managing unit 128 of a completion of the invalidation of the ticket (Step S27). The log managing unit 128 records the security log in the log-omission determination table that has been temporarily stored, according to a need. The application notifies the receiving unit 122 of an execution result of the processing corresponding to the predetermined processing request (Step S28). Thus, the process for storing the security log is completed.

In the process shown in FIG. 9, one processing request and a series of processes performed based on the one processing request, that is, processes from reception of the login request to the notification of the execution request (Step S11 to Step S28), are considered as one entity, and one ticket is generated and issued for the one entity. Then, one security log is stored for the executed predetermined processing.

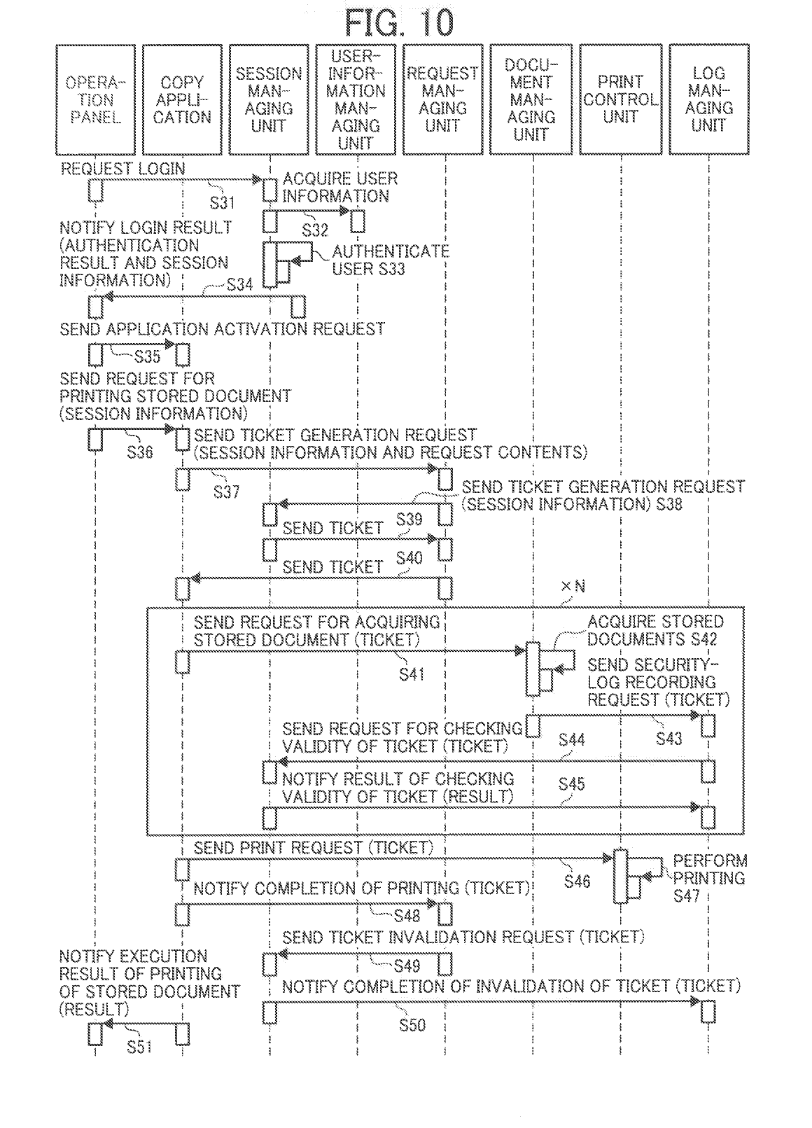

A process for storing the security log when the document managing unit 132 and the print control unit 131 of the platform unit 120 perform a process for printing a stored document is described in detail below. FIG. 10 is a sequence diagram of the process for storing the security log by the MFP 100.

The processes from sending of the login request to the session managing unit 125 to notification of the login result (Step S31 to Step S34) are the same as those shown in FIG. 9 (Step S11 to Step S14).

Upon receiving a request for printing a stored document (hereinafter, “stored-document print request”) from the user who has logged in as a result of user authentication success via the operation panel 106, the receiving unit 122 sends an activation request for activating the copy application 112 that performs a process for printing the stored document (hereinafter, “stored-document printing process”) (Step S35), and sends the stored-document print request for printing the stored document to the copy application 112 that has been activated (Step S36).

Upon receiving the stored-document print request, the copy application 112 sends the session information and requested contents to the request managing unit 127, and sends a ticket generation request for one entity according to the stored-document print request to the request managing unit 127 (Step S37). Upon receiving the ticket generation request, the request managing unit 127 sends the ticket generation request to the session managing unit 125 (Step S38).

Upon receiving the ticket generation request, the session managing unit 125 generates a ticket corresponding to the one stored-document print request sent by the user, and sends the ticket to the request managing unit 127 (Step S39). At this time, the session managing unit 125 checks validity of the session information. Then, the request managing unit 127 sends the ticket to the copy application 112 (Step S40).

Upon acquiring the ticket, the copy application 112 sends a request for acquiring the stored document identified by the stored-document print request, together with the ticket, to the document managing unit 132 (Step S41). The document managing unit 132 acquires the identified stored document from the HDD 103 (Step S42), and sends a security-log recording request together with the ticket to the log managing unit 128 (Step S43).

The log managing unit 128 sends a check request for checking validity of the acquired ticket to the session managing unit 125 (Step S44). The session managing unit 125 checks the validity of the ticket and sends a result of checking the validity of the ticket to the log managing unit 128 (Step S45). When the ticket is valid, the log managing unit 128 records a security log in the HDD 103 based on the recording pattern set in the recording-pattern set table. At this time, the process for acquiring the stored document is recorded as “reference of the document” in the security log.

When a plurality of documents, for example, as many documents as N, is printed according to the one stored-document print request, the processes from Step S41 to Step S45 are repeated N times, so that the security logs are recorded N times.

Upon acquiring the identified stored document, the copy application 112 sends a print request for printing the stored document together with the ticket to the print control unit 131 (Step S46). The print control unit 131 executes printing of the stored document acquired by the printer (Step S47). In this example, it is assumed that the security log is not recorded with regard to execution of printing, so that the security log related to the printing is not recorded.

When the printing based on the stored-document print request is completed, the copy application 112 notifies the request managing unit 127 of a completion of the printing together with the ticket (Step S48). The request managing unit 127 sends an invalidation request for invalidating the ticket to the session managing unit 125 (Step S49).

Upon receiving the invalidation request, the session managing unit 125 invalidates the ticket and notifies the log managing unit 128 of a completion of the invalidation of the ticket (Step S50). The log managing unit 128 records the security log in the log-omission determination table that has been temporarily stored, according to a need. The copy application 112 notifies the receiving unit 122 of an execution result of the stored-document printing process (Step S51). Thus, the process for storing the security log in the stored-document printing process is completed.

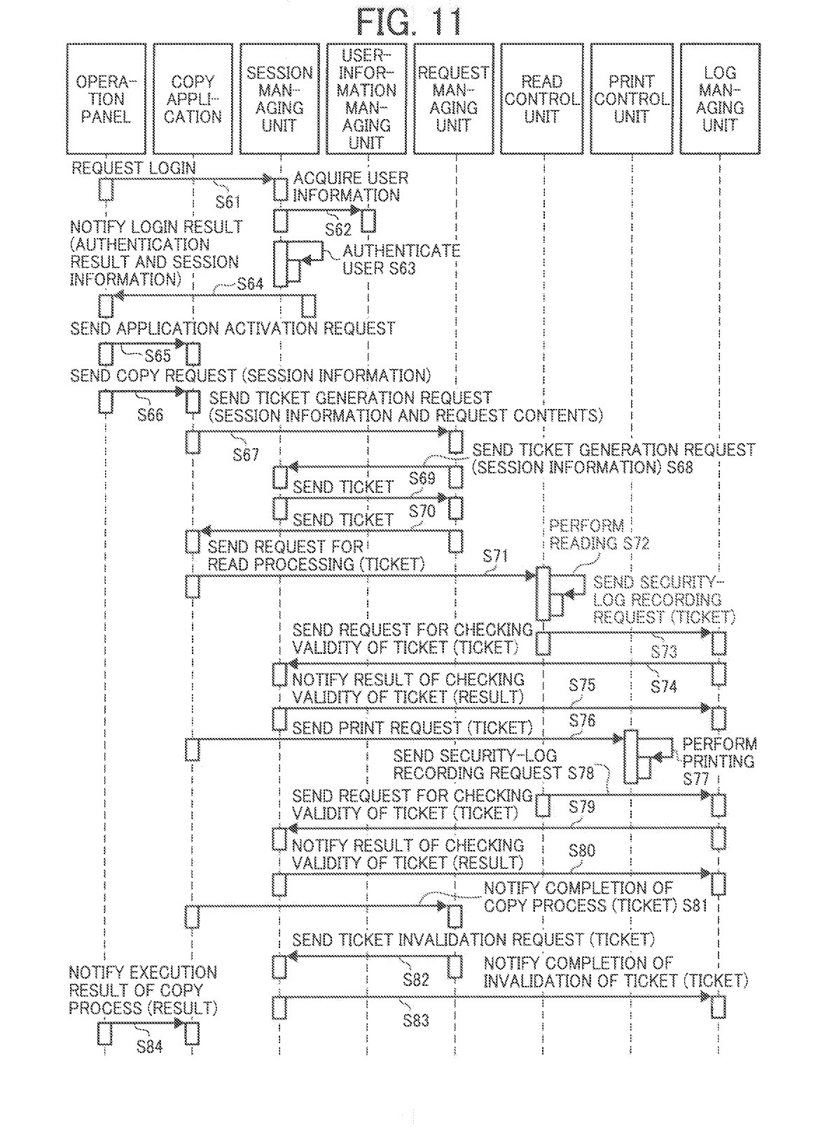

A process for storing the security log when the read control unit 129 and the print control unit 131 of the platform unit 120 perform a copy process is described in detail below. FIG. 11 is a sequence diagram of the process for storing the security log by the MFP 100.

The processes from sending of the login request to the session managing unit 125 to notification of the login result (Step S61 to Step S64) are the same as those shown in FIG. 9 (Step S11 to Step S14).

Upon receiving a copy request from the user who has logged in as a result of user authentication success via the operation panel 106, the receiving unit 122 sends an activation request for activating the copy application 112 that performs a copy process (Step S65), and sends the copy request to the copy application 112 that has been activated (Step S66).

Upon receiving the copy request, the copy application 112 sends the session information and requested contents to the request managing unit 127, and sends a ticket generation request for one entity according to the copy request to the request managing unit 127 (Step S67). Upon receiving the ticket generation request, the request managing unit 127 sends the ticket generation request to the session managing unit 125 (Step S68).

Upon receiving the ticket generation request, the session managing unit 125 generates a ticket corresponding to the one copy request sent by the user, and sends the ticket to the request managing unit 127 (Step S69). At this time, the session managing unit 125 checks validity of the session information. Then, the request managing unit 127 sends the ticket to the copy application 112 (Step S70).

Upon acquiring the ticket, the copy application 112 sends a request for reading an original, together with the ticket, to the read control unit 129 (Step S71). The read control unit 129 reads the original by using the scanner (Step S72), and sends a security-log recording request together with the ticket to the log managing unit 128 (Step S73).

The log managing unit 128 sends a check request for checking validity of the acquired ticket to the session managing unit 125 (Step S74). The session managing unit 125 checks the validity of the ticket and sends a result of checking the validity of the ticket to the log managing unit 128 (Step S75). When the ticket is valid, the log managing unit 128 records a security log in the HDD 103 based on the recording pattern set in the recording-pattern set table.

Upon reading the original, the copy application 112 sends a print request for printing a read image, together with the ticket, to the print control unit 131 (Step S76). The print control unit 131 prints the image read by the printer (Step S77), and sends the security-log recording request together with the ticket to the log managing unit 128 (Step S78).

The log managing unit 128 sends a check request for checking validity of the acquired ticket to the session managing unit 125 (Step S79). The session managing unit 125 checks the validity of the ticket and sends a result of checking the validity of the ticket to the log managing unit 128 (Step S80). When the ticket is valid, the log managing unit 128 records a security log in the HDD 103 based on the recording pattern set in the recording-pattern set table.

When the reading process and the printing process based on the copy request are completed, the copy application 112 notifies the request managing unit 127 of a completion of the copy process together with the ticket (Step S81). The request managing unit 127 sends an invalidation request for invalidating the ticket to the session managing unit 125 (Step S82).

Upon receiving the invalidation request, the session managing unit 125 invalidates the ticket and notifies the log managing unit 128 of a completion of the invalidation of the ticket (Step S83). The log managing unit 128 records the security log in the log-omission determination table that has been temporarily stored, according to a need. The copy application 112 notifies the receiving unit 122 of an execution result of the copy process (Step S84). Thus, the process for storing the security log when the copy process is completed.

In this manner, the MFP 100 generates a ticket for each entity containing one processing request and a series of processes to be executed based on the one processing request, causes the execution processing unit of the platform unit 120 to execute predetermined processing by using the ticket, and records the security log according to the one processing request. Furthermore, the MFP 100 records the security log in processes other than the processes described above. For example, when a communication process is performed, and if a critical error occurs, or if important information is detected from an image obtained by scanning an original, the MFP 100 generates a ticket, performs processing by using the generated ticket, and records the security log.

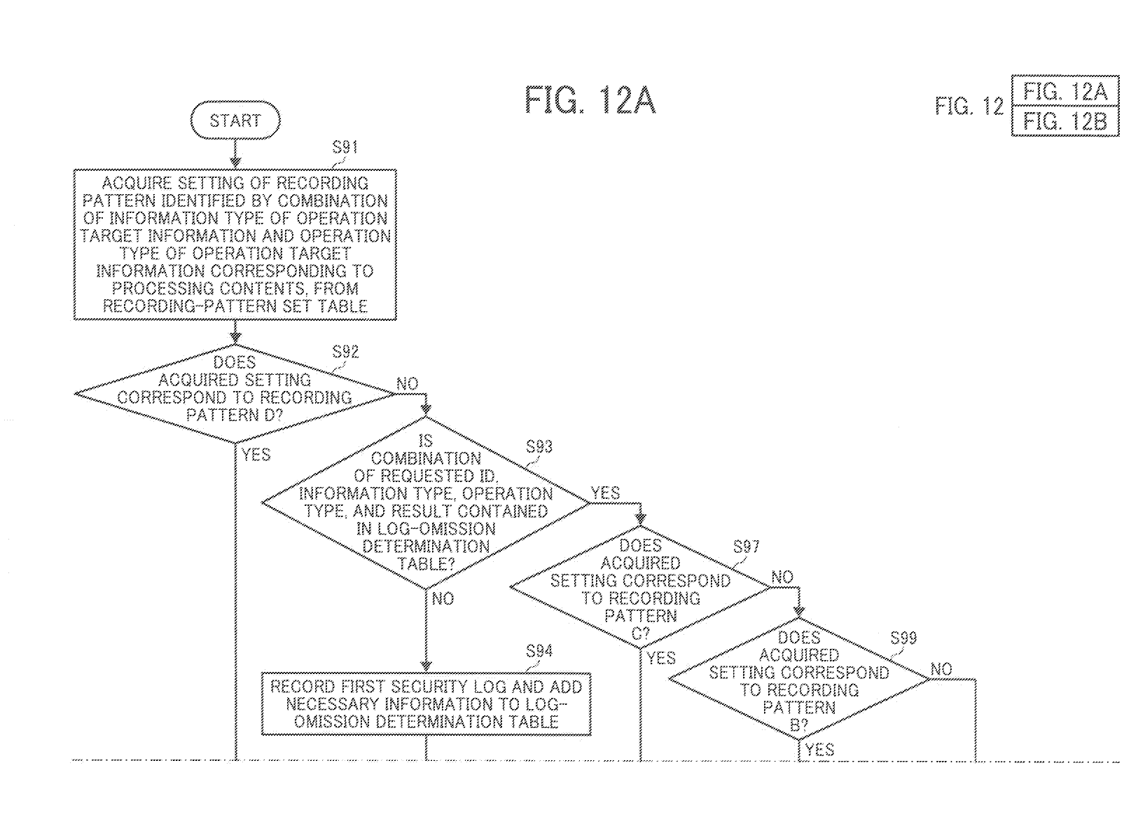

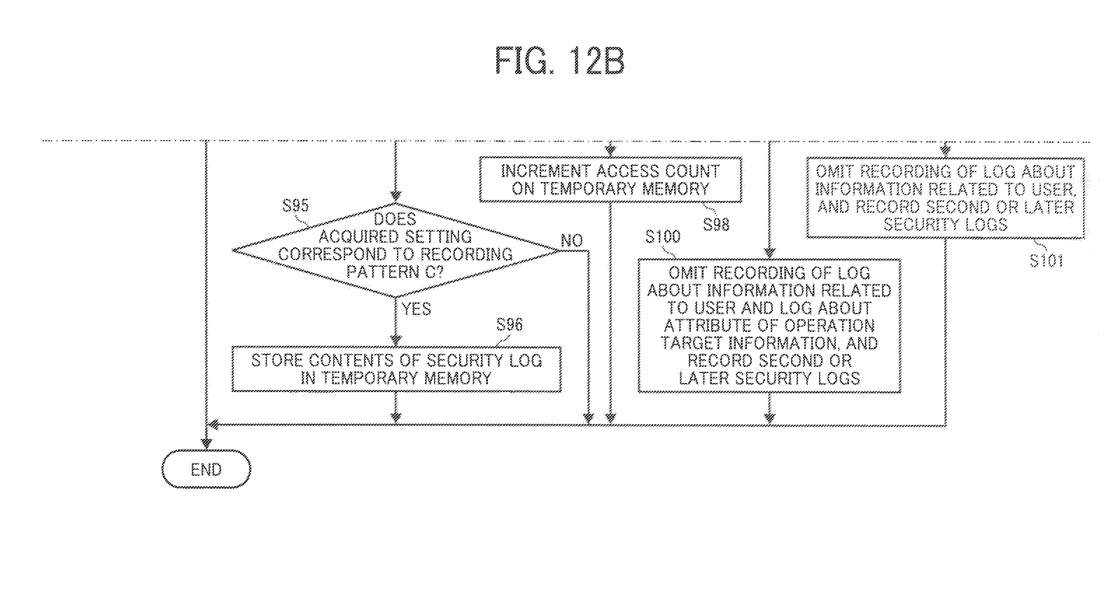

A process for recording the security log by the log managing unit 128 when a request for recording the security log is sent to the log managing unit 128 (i.e., Step S22 in FIG. 9, Step S43 in FIG. 10, and Step S73 and Step S78 in FIG. 11) is described below. FIG. 12 is a flowchart of the process for recording the security log.

When any one of the execution processing units of the platform unit 120, which performs predetermined processing based on the processing request, issues the security-log recording request, the log managing unit 128 acquires a setting of the recording pattern identified by a combination of a type of the operation target information and an operation type of the operation target information corresponding to the processing contents, from the recording-pattern set table (Step S91).

The log managing unit 128 determines whether the acquired setting of the recording pattern corresponds to the recording pattern D (Step S92). When the acquired setting corresponds to the recording pattern D (YES at Step S92), because the security log is not recorded, process control ends.

On the other hand, when the acquired setting does not correspond to the recording pattern D (NO at Step S92), the log managing unit 128 determines whether a combination of a request ID of the processing performed by the execution processing unit based on the processing request, a type of the operation target information, an operation type of the operation target information, and an execution result of the processing is contained in the log-omission determination table (Step S93).

When the combination is not contained in the log-omission determination table (NO at Step S93), the log managing unit 128 determines that the security log requested to be recorded corresponds to the first log, records the first security log in the HDD 103, and additionally records necessary information (the request ID, the type of the operation target information, the operation type of the operation target information, and the execution result) in the log-omission determination table (Step S94). In this case, because the security log is the first log, logs of all items are recorded without omission.

The log managing unit 128 determines whether the acquired setting of the recording pattern corresponds to the recording pattern C (Step S95). When the acquired setting corresponds to the recording pattern C (YES at Step S95), the log managing unit 128 stores the contents of the security log in a temporary memory (not shown) (Step S96), and ends the processing. Then, the log managing unit 128 records a subsequently-generated security log.

On the other hand, when the acquired setting does not correspond to the recording pattern C (NO at Step S95), the log managing unit 128 ends the processing and then records a subsequently-generated security log.

At Step S93, when the combination is contained in the log-omission determination table (YES at Step S93), the log managing unit 128 determines that the security log requested to be recorded is the second or later log, and determines whether the acquired setting of the recording pattern corresponds to the recording pattern C (Step S97). When the acquired setting corresponds to the recording pattern C (YES at Step S97), the log managing unit 128 increments the access count on the temporary memory (not shown) (Step S98). The log managing unit 128 ends the processing and then records a subsequently-generated security log. When the processing based on the processing contents is completed, the log managing unit 128 records the access count stored in the temporary memory in the security log.

At Step S97, when the acquired setting does not correspond to the recording pattern C (NO at Step S97), the log managing unit 128 determines whether the acquired setting of the recording pattern corresponds to the recording pattern B (Step S99). When the acquired setting corresponds to the recording pattern B (YES at Step S99), the log managing unit 128 records the second or later security log while omitting recording of the logs corresponding to the information related to the user and the attributes 1 to 3 of the operation target information (see FIG. 4) (Step S100).

On the other hand, when the acquired setting does not correspond to the recording pattern B (NO at Step S99), the acquired setting is identified as the recording pattern A, so that the log managing unit 128 records the second or later security log while omitting recording of logs corresponding to the information related to the user (Step S101).

In this manner, the MFP 100 generates a ticket for each entity containing one processing request and a series of processes to be executed based on the one processing request, and causes the execution processing unit of the platform unit 120 to execute predetermined processing by using the ticket. Accordingly, the MFP 100 can record the security log with reduced size by recording the security log in the HDD 103 while omitting recording of the redundant logs and the unnecessary logs according to the predetermined recording pattern with respect to each processing request indicated by the ticket.

A second embodiment of the present invention is described below. In the MFP 100 according to the first embodiment, the security log is stored in the platform unit 120. However, an MFP according to the second embodiment is configured to store a print log in the application unit when the application unit prints print data.

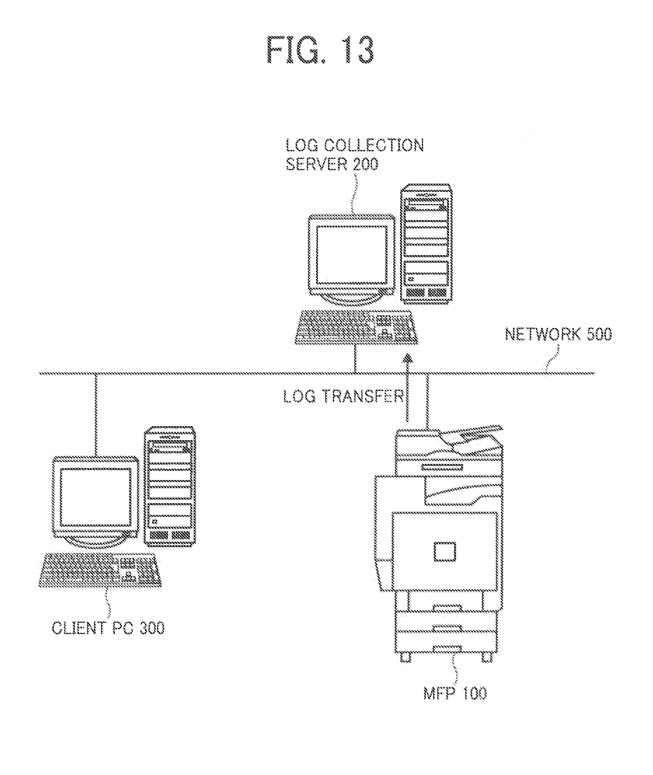

FIG. 13 is a schematic diagram illustrating an example of an image forming system according to the second embodiment. The image forming system includes the MFP 100, a log collection server 200, and a client PC 300, which are connected to one another via a network 500.

The client PC 300 mainly includes a communication unit, a data storage unit, an application unit, a display unit, and an input unit, which are not shown. When printing print data stored in the data storage unit, the client PC 300 transmits the print data and a print request for the print data from the communication unit to the MFP 100.

The network 500 is, for example, a phone line, a wireless network, or the Internet, and connects the MFP 100, the log collection server 200, and the client PC 300 to one another.

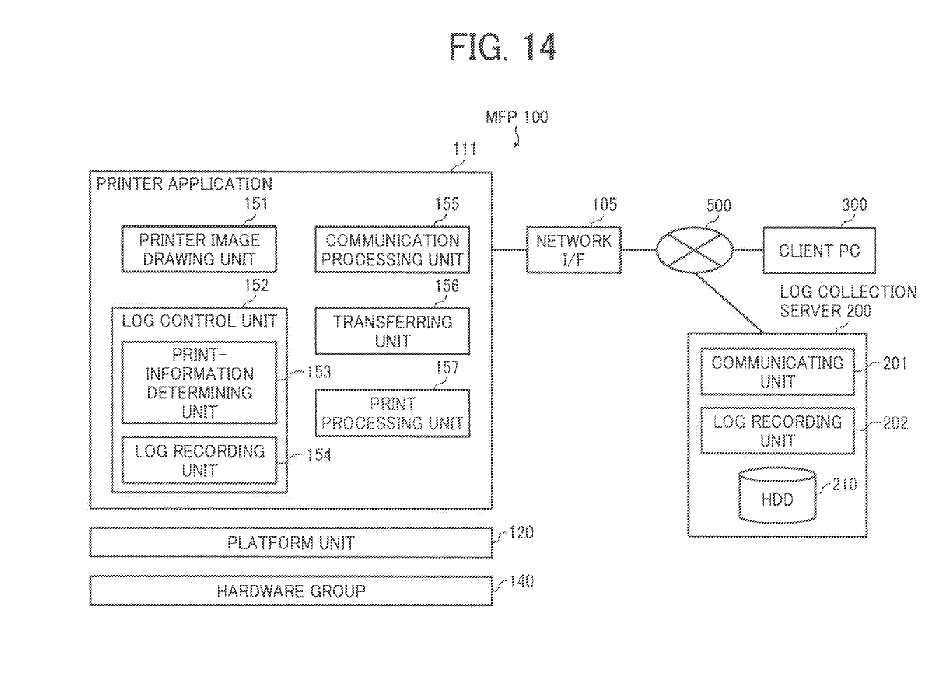

The MFP 100 and the log collection server 200 are explained in detail below. FIG. 14 is a block diagram of configurations of the MFP 100 and the log collection server 200. The MFP 100 stores, when print data transmitted from the client PC 300 is printed or data read by a scanner unit (not shown) is printed, a print log that is a history of a printing process performed on the print data and transfers the print log to the log collection server 200. The MFP 100 is connected to the client PC 300 and the log collection server 200 via the network I/F 105 and the network 500.

The MFP 100 according to the second embodiment has the same configuration as the MFP 100 described in the first embodiment. The printer application 111 that performs printing in the MFP 100 is described in detail below with reference to FIG. 14.

The operation panel 106 according to the second embodiment has a function of, in addition to the functions described in the first embodiment, receiving, from a user, an input of a selection instruction indicating whether to delete the transferred print log from the MFP 100 when a predetermined time has elapsed since transfer of the print log from the MFP 100 to the log collection server 200.

The HDD 103 according to the second embodiment is a storage medium for storing, when a print processing unit 157, which will be described later, prints print data by using a printer engine (not shown), a print log that is a history of print information related to printing of the print data and the number of printed sheets. The print information contains information about a type of a paper to which the print data is printed (a sheet type), such as “plain sheet” or “recycle paper”, and a print mode, such as “color print” or “monochrome print”.

The printer application 111 of the MFP 100 is an application that performs processing on the print data. As shown in FIG. 14, the printer application 111 mainly includes a printer image drawing unit 151, a log control unit 152, a communication processing unit 155, a transferring unit 156, and the print processing unit 157.

The communication processing unit 155 performs communication processing for a communication with an external apparatus such as the client PC 300. Examples of the communication processing unit 155 include a file transfer protocol (FTP) server. In the second embodiment, the communication processing unit 155 is configured to receive print data and a print request for the print data from the client PC 300.

The printer image drawing unit 151 performs, when receiving the print data and the print request for the print data from the client PC 300, image processing on the received print data, and sends “a print-log recording start instruction” that is an instruction for starting recording of the print log to the log control unit 152. The printer image drawing unit 151 sends “a printing-process start instruction” as an instruction for starting printing to the print processing unit 157 based on the received print request. Upon receiving “a printing-process completion notice” as a notification of a completion of the printing from the print processing unit 157, the printer image drawing unit 151 sends “a print-log recording instruction” as an instruction for recording the print log to the log control unit 152.

When printing for one print job corresponding to the processing request indicated by the ticket is completed, the printer image drawing unit 151 sends “a print-log recording termination instruction” as an instruction for terminating recording of the print log to the log control unit 152.

The log control unit 152 performs processing related to recording of the print log. The log control unit 152 includes a print-information determining unit 153 and a log recording unit 154.

The print-information determining unit 153 determines, when receiving “the print-log recording instruction” from the printer image drawing unit 151, whether print information corresponding to print information obtained when the print processing unit 157 prints the print data (hereinafter, “new print information”) is already contained in the print log stored in the HDD 103. More particularly, the print-information determining unit 153 compares a sheet type, a sheet size, and a print mode in the new print information that is obtained when the print data is printed with a sheet type, a sheet size, and a print mode in the print information contained in the print log stored in the HDD 103. Then, when all items are identical between the print information and the new print information, the print-information determining unit 153 determines that the print information identical to the new print information is already contained in the HDD 103. On the other hand, when at least one item is not identical between the print information and the new print information, the print-information determining unit 153 determines that the print information identical to the new print information is not contained in the print log stored in the HDD 103.

The log recording unit 154 records a print log by writing a print log created through printing of the print data in the HDD 103. In the second embodiment, the log recording unit 154 starts recording the print log when receiving “the print-log recording start instruction” from the printer image drawing unit 151. More particularly, the log recording unit 154 goes to a state in which the log recording unit 154 records the print log related to the printing even when, at a later time, print data is printed and the log recording unit 154 receives “the print-log recording instruction” from the printer image drawing unit 151. Upon receiving “the print-log recording termination instruction” from the printer image drawing unit 151, the log recording unit 154 terminates recording of the print log. More particularly, the log recording unit 154 goes to a state in which the log recording unit 154 does not record a print log related to the printing even when print data is printed at a later time.

When the print-information determining unit 153 determines that the print information identical to the new print information obtained when the print data is printed is already contained in the print log stored in the HDD 103, the log recording unit 154 updates the number of printed sheets by increasing a count of the printed sheets contained in the identical print information stored in the HDD 103 to the number of actually printed sheets. At this time, the log recording unit 154 does not record the new print information as the print log because the same print information is already stored.

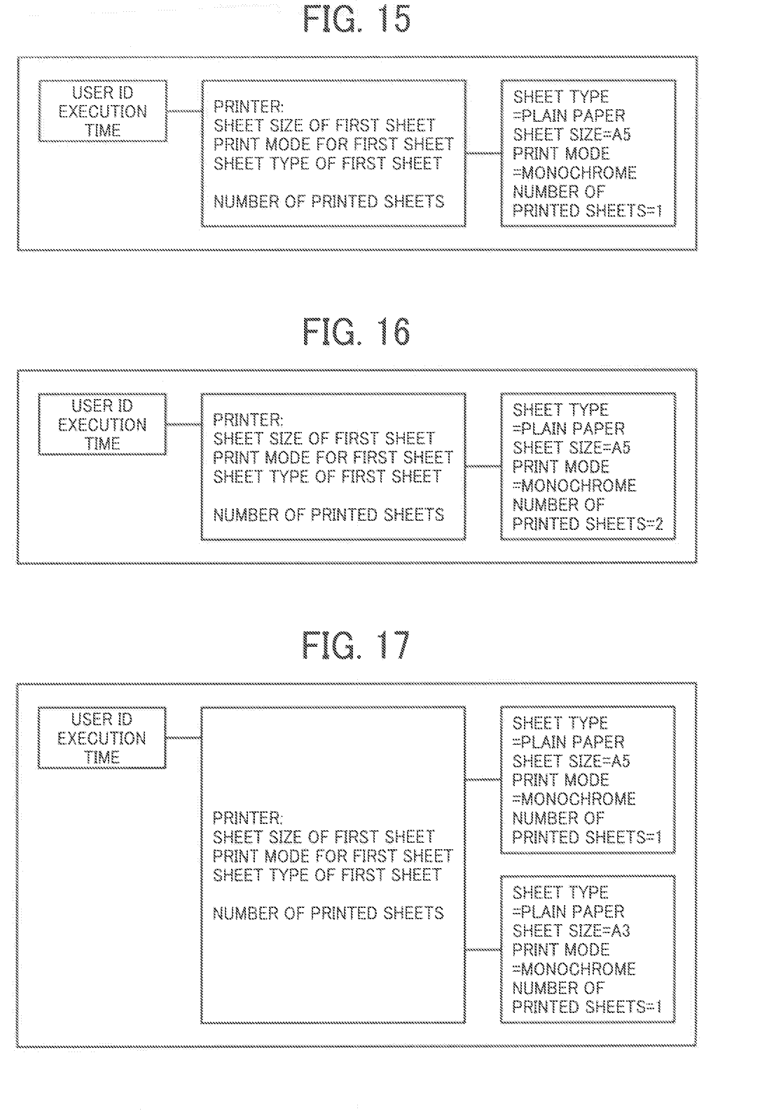

A process for updating the number of printed sheets without recording the new print information is described in detail below with reference to the drawings. FIG. 15 is a schematic diagram illustrating an example of a print log created when print data of a first sheet is printed. On the left side of the print log, “user ID” for identifying a user and “execution time” indicating date and time when the printing is performed are contained. In the center of the print log, the print log related to the scanner and the printer is stored. For a printer, “sheet size”, “print mode”, and “sheet type”, which are items of the print information, and “the number of printed sheets” are stored. On the right side of the print log, print information obtained when the print data is actually printed and a print log as a history of the number of printed sheets are contained. More particularly, in the example shown in FIG. 15, it is indicated that one sheet is printed based on the print information indicating that the sheet type is a plain sheet, the sheet size is A5, and the print mode is the monochrome mode.

FIG. 16 is a schematic diagram illustrating an example of a print log created when print data of a second sheet is printed. Similar to the print data of the first sheet, for the print data of the second sheet, if printing is performed under the condition that the sheet type is the plain sheet, the sheet size is A5, and the print mode is the monochrome mode, the log recording unit 154 increments the count of the number of the printed sheet, so that the number of printed sheets is updated to “2”. Accordingly, the print log with the accurate contents can be stored without recording the new print information.

When the print-information determining unit 153 determines that the print information identical to the new print information obtained when the print data is printed is not contained in the print log stored in the HDD 103, the log recording unit 154 records the new print information as the print information of the print log in the HDD 103.

FIG. 17 is a schematic diagram of another example of a print log created when the print data of the second sheet is printed. When, as shown in FIG. 17, print data of the second sheet is printed under the condition that, unlike the print data of the first sheet, the sheet type is the plain sheet, the sheet size is A3, and the print mode is the monochrome mode, the log recording unit 154 records a print log together with the print information obtained when the print data of the second sheet is printed. Accordingly, even when identical print information is not stored, the print log with the accurate contents can be stored. If print data of the third or later sheet is printed using the same print information, the print log with the accurate contents can be stored only by updating the number of printed sheets.

“Recording of the print log” is described in detail below. As described above, the log recording unit 154 performs both a process for updating the number of printed sheets without recording the new print information and a process for recording the new print information as the print information of the print log. In the second embodiment, these two processes are collectively referred to as “recording of the print log”.

The log recording unit 154 performs the recording of the print log including updating of the print information and recording of the new print information, with respect to each print job by which the print data is printed. When completing the recording of the print log, the log recording unit 154 sends “a print-log transfer instruction” as an instruction for transferring the print log to the transferring unit 156.

Upon receiving the selection instruction indicating deletion of the print log via the operation panel 106, the log recording unit 154 deletes the print log from the HDD 103 when a predetermined time has elapsed since transfer of the print log from the transferring unit 156 to the log collection server 200.

The transferring unit 156 transfers, when one print job is completed and the transferring unit 156 receives “the print-log transfer instruction” from the log recording unit 154, the print log stored in the HDD 103 to the log collection server 200. Examples of the transferring unit 156 include an http client.

The print processing unit 157 controls a printer engine to print the print data acquired by reading an original by the scanner. More particularly, upon receiving “the printing-process start instruction” as an instruction for starting printing from the printer image drawing unit 151, the print processing unit 157 prints the print data. Then, when completing the printing, the print processing unit 157 sends “the printing-process completion notice” as a notification of a completion of the printing to the printer image drawing unit 151.

The log collection server 200 is described in detail below. The log collection server 200 is a server for collecting and storing print logs. As shown in FIG. 14, the log collection server 200 mainly includes a communicating unit 201, a log recording unit 202, and an HDD 210.

The communicating unit 201 performs communication processing with an external apparatus such as the MFP 100. In the second embodiment, the communicating unit 201 receives a print log transmitted from the MFP 100. The log recording unit 202 records the print log received by the communicating unit 201 in the HDD 210. The HDD 210 is a storage medium for storing the print log received from the MFP 100.

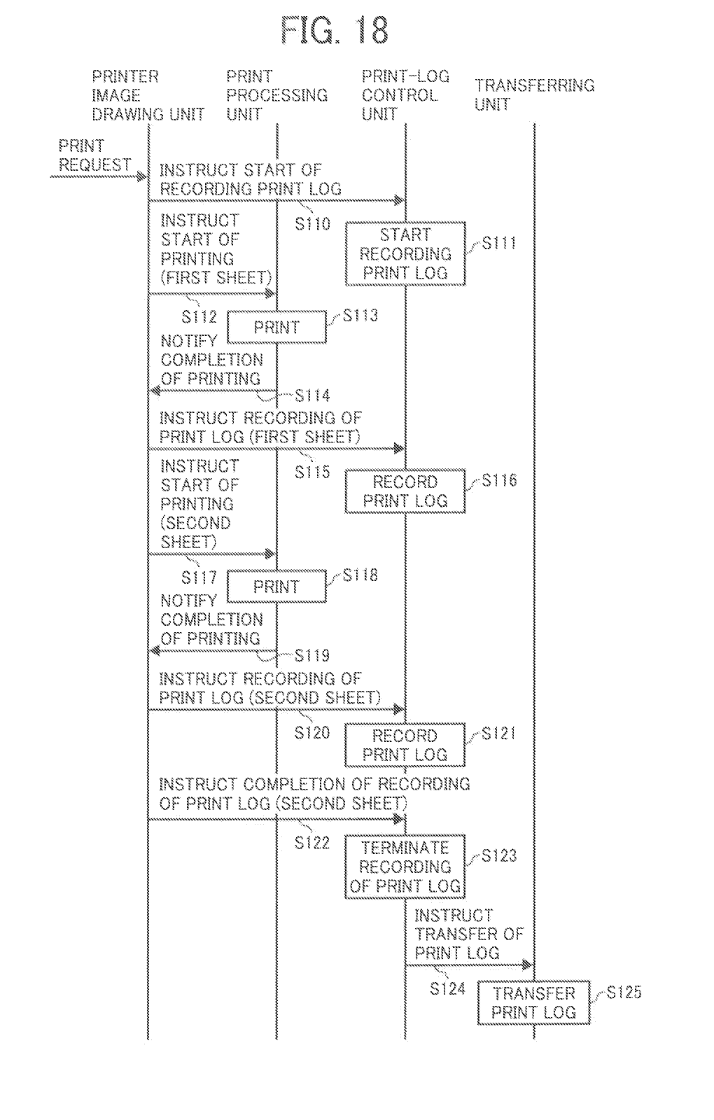

A process for storing the print log by the MFP 100 having the above-described configuration is described in detail below. FIG. 18 is a sequence diagram of a process for storing the print log by the MFP 100 according to the second embodiment. In the example shown in FIG. 18, print data for two sheets is printed as one print job corresponding to the processing request indicated by the ticket.

Upon receiving print data and a print request for the print data from the client PC 300, the printer image drawing unit 151 sends “the print-log recording start instruction” to the log control unit 152 (Step S110). Upon receiving “the print-log recording start instruction”, the log control unit 152 starts recording the print log (Step S111).

The printer image drawing unit 151 sends “the printing-process start instruction” for the first sheet to the print processing unit 157 (Step S112). Then, the print processing unit 157 prints the print data of the first sheet (Step S113). Upon receiving “the printing-process completion notice” from the print processing unit 157 (Step S114), the printer image drawing unit 151 sends “the print-log recording instruction” for the first sheet to the log control unit 152 (Step S115). Then, upon receiving “the print-log recording instruction”, the log control unit 152 records the print log in the HDD 103 (Step S116).

The printer image drawing unit 151 then sends “the printing-process start instruction” for the second sheet to the print processing unit 157 (Step S117). Then, the print processing unit 157 prints the print data of the second sheet (Step S118). Upon receiving “the printing-process completion notice” from the print processing unit 157 (Step S119), the printer image drawing unit 151 sends “the print-log recording instruction” for the second sheet (Step S120). Then, upon receiving “the print-log recording instruction”, the log control unit 152 records the print log in the HDD 103 (Step S121).

At this time, in the MFP 100 according to the second embodiment, when the print information of the second sheet is identical to the print information of the first sheet, the log control unit 152 records the print log by updating the number of printed sheets as shown in FIG. 16. On the other hand, when the print information of the second sheet is not identical to the print information of the first sheet, the log control unit 152 records the print log by writing the print information of the second sheet as shown in FIG. 17.

When printing according to the one print job is completed (printing for the two sheets is completed in the example shown in FIG. 18), the printer image drawing unit 151 sends “the print-log recording termination instruction” to the log control unit 152 (Step S122). Upon receiving “the print-log recording termination instruction”, the log control unit 152 terminates recording of the print log (Step S123).

Then, the log control unit 152 sends “the print-log transfer instruction” to the transferring unit 156 (Step S124). The transferring unit 156 then transfers the print log stored in the HDD 103 to the log collection server 200 (Step S125). When receiving the selection instruction indicating deletion of the print log via the operation panel 106, the log recording unit 154 deletes the print log from the HDD 103 after a predetermined time has elapsed. Then, the process by the MFP 100 ends.

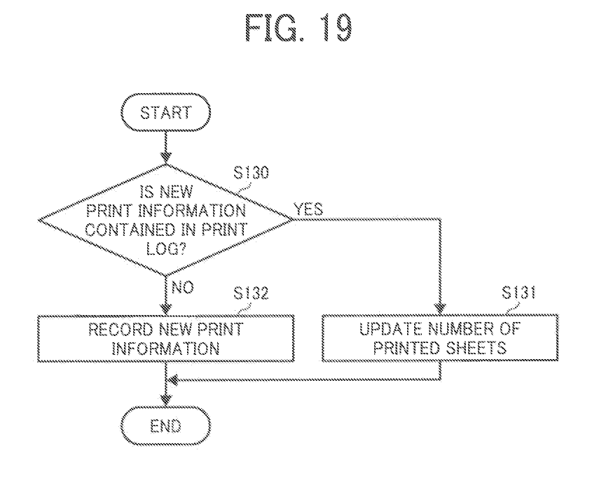

Recording of the print log at Step S116 and Step S121 in FIG. 18 is described in detail below. FIG. 19 is a flowchart of the process for recording the print log by the MFP 100 according to the second embodiment.

When the log control unit 152 receives “the print-log recording instruction” from the printer image drawing unit 151 (see Step S115 and Step S120 in FIG. 18), the print-information determining unit 153 determines whether print information identical to new print information obtained when the print processing unit 157 prints the print data is already contained in the print log stored in the HDD 103 (Step S130).

When it is determined that the print information identical to the print information is already contained in the print log (YES at Step S130), the log recording unit 154 increments the count of the number of printed sheets in the identical print information stored in the HDD 103 to update the number of printed sheets (Step S131). At this time, the log recording unit 154 does not record the new print information as the print log in the HDD 103.

On the other hand, when it is determined that the print information identical to the new print information is not contained in the print log (NO at Step S130), the log recording unit 154 records the new print information as the print information of the print log in the HDD 103 (Step S132).

In this manner, in the MFP 100 according to the second embodiment, when the print information identical to the new print information obtained when the print data is printed is already contained in the print log stored in the HDD 103, the new print information is not recorded as the print log, while the number of printed sheets in the identical print information stored in the HDD 103 is updated. On the other hand, when the print information identical to the new information is not contained in the print log stored in the HDD 103, the new print information is recorded as the print information of the print log. When storing of the print log of the printing process according to one print job corresponding to the processing request indicated by the ticket is completed, the print log is transferred to the log collection server 200, so that the log collection server 200 stores therein and manages the print log. As described above, the MFP 100 is configured to store all new print information by either updating the number of printed sheets or recording the new printed information, so that the new print information can be stored accurately. More particularly, when the new print information is already stored, the MFP 100 only updates the number of printed sheets, so that it is possible to store the print log with a reduced size.

The MFP 100 according to the second embodiment is configured to print the print data, store a print log generated through the printing, and transfers the stored print log to the log collection server when one print job corresponding to the processing request indicated by the ticket is completed so that the log collection server 200 can store therein and manage the print log. However, the MFP 100 can be configured such that the print log is not transferred. In other words, the MFP 100 can be configured such that the MFP 100 manages the print log when printing the print data and storing the print log generated through the printing, without transferring the stored print log to the log collection server 200.

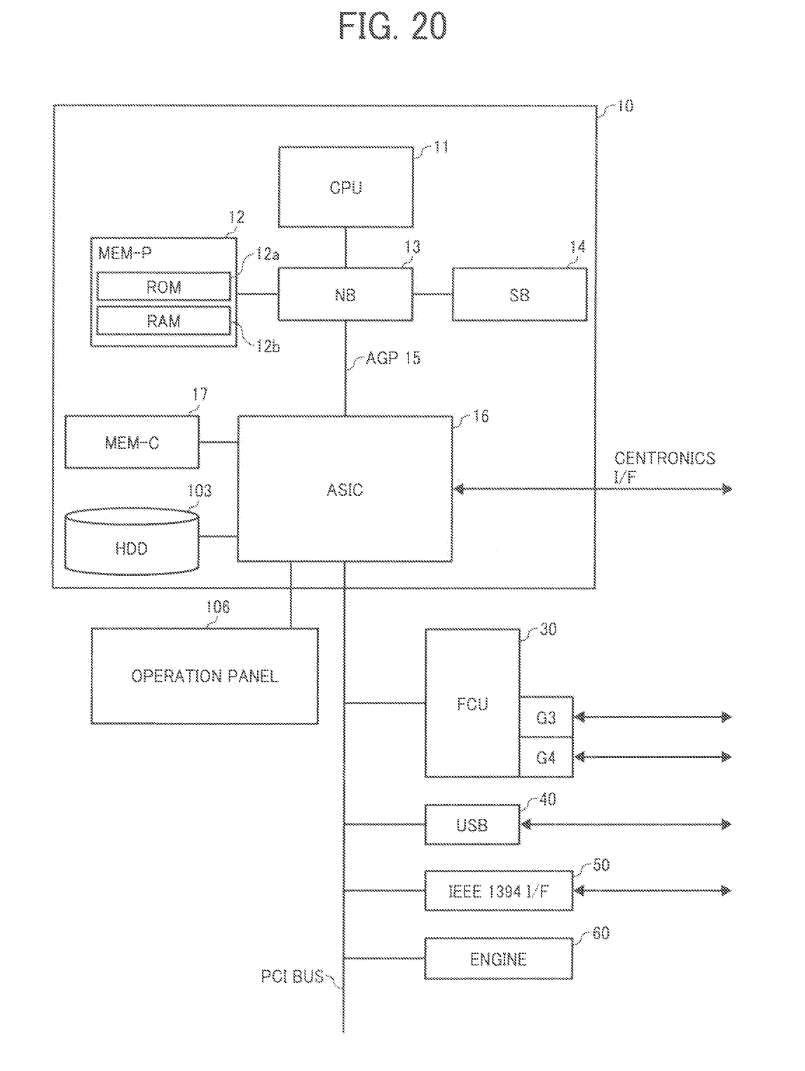

FIG. 20 is a block diagram of a hardware configuration of the MFP 100 according to the first and the second embodiments. As shown in FIG. 20, the MFP 100 includes a controller 10 and an engine 60 that are connected by a peripheral component interconnect (PCI) bus. The controller 10 controls the MFP 100 and controls imaging, communication, and an input from an operating unit (not shown). The engine 60 is a printer engine that can be connected to the PCI bus. For example, the engine 60 is a black and white plotter, a single drum color plotter, a four drum color plotter, a scanner, or a fax unit. In addition to an engine portion such as the plotter, the engine 60 also includes an image processing portion such as an error diffuser or a gamma converter.

The controller 10 includes a CPU 11, a north bridge (NB) 13, a system memory (MEM-P) 12, a south bridge (SB) 14, a local memory (MEM-C) 17, an application specific-integrated circuit (ASIC) 16, and the HDD 103. The NB 13 and the ASIC 16 are connected by an accelerated graphics port (AGP) 15. The MEM-P 12 includes a ROM 12a and a RAM 12b.

The CPU 11 controls the MFP 100. The CPU 11 includes a chipset that includes the NB 13, the MEM-P 12, and the SB 14. The CPU 11 is connected to other devices via the chipset.

The NB 13 connects the CPU 11 to the MEM-P 12, the SB 14, and the AGP 15. The NB 13 includes a memory controller, which controls read/write with respect to the MEM-P 12, a PCI master, and an AGP target.

The MEM-P 12 is used as a memory for storing therein computer programs and data, as a memory for expanding the computer programs and the data, and as a memory for printer imaging. The MEM-P 12 includes the ROM 12a and the RAM 12b. The ROM 12a is used as a memory for storing therein the computer programs and the data. The RAM 12b is used as a memory for expanding the computer programs and the data and as a memory for printer imaging.

The SB 14 connects the NB 13 with the PCI device and surrounding devices. The SB 14 is connected to the NB 13 via the PCI bus. A network interface (I/F) is also connected to the PCI bus.

The ASIC 16 is an IC for image processing that includes a hardware element for image processing. The ASIC 16 functions as a bridge that connects the AGP 15, the PCI bus, the HDD 103, and the MEM-C 17. The ASIC 16 includes a PCI target and an AGP master, an arbiter (ARB) that forms a core of the ASIC 16, a memory controller that controls the MEM-C 17, a plurality of direct memory access controllers (DMAC) that carry out rotation of the image data using hardware logic, and a PCI unit that carries out data transfer between the ASIC 16 and the engine 60 via the PCI bus. A facsimile control unit (FCU) 30, a universal serial bus (USB) 40, an institute of electrical and electronics engineers 1394 (IEEE 1394) I/F 50 are connected to the ASIC 16. The operation panel 106 is directly connected to the ASIC 16.

The MEM-C 17 is a local memory that is used as an image buffer for copying and as a code buffer. The HDD 103 is a storage unit for storing therein the image data, the computer programs, font data, and a form.

The AGP 15 is a bus I/F for a graphics accelerator card that is suggested for enhancing the speed of a graphic process. The AGP 15 directly accesses the MEM-P 12 at a high throughput, thus enhancing the speed of the graphics accelerator card.

A log storing program, which is executed by the MFP 100, is provided by prior embedding the log storing program in a ROM, etc.

The log storing program can also be provided by recording the log storing program as a file of installable format or executable format in a computer readable-recording medium such as a CD-ROM, an FD, a CD-R, or a DVD.

The log storing program can also be stored in a computer that is connected to a network such as the Internet, and can be provided by downloading the log storing program via the network. Further, the log storing program can be provided or distributed via the network such as the Internet.

The log storing program executed by the MFP 100 according to the first and the second embodiments has a module structure containing the above described units (i.e., the receiving unit 122, the FAX transmitting-receiving unit 123, the e-mail transmitting-receiving unit 124, the session managing unit 125, the user-information managing unit 126, the request managing unit 127, the log managing unit 128, the read control unit 129, the print control unit 131, the document managing unit 132, the address-book managing unit 133, the initial-setting managing unit 134, the help-information managing unit 135, the macro-information managing unit 136, the printer image drawing unit 151, the log control unit 152, the communication processing unit 155, the transferring unit 156, and the print processing unit 157). As actual hardware, a CPU (processor) reads the log collection program from a ROM and executes the log collection program, so that the above described units are loaded on a main storage apparatus. As a result, the receiving unit 122, the FAX transmitting-receiving unit 123, the e-mail transmitting-receiving unit 124, the session managing unit 125, the user-information managing unit 126, the request managing unit 127, the log managing unit 128, the read control unit 129, the print control unit 131, the document managing unit 132, the address-book managing unit 133, the initial-setting managing unit 134, the help-information managing unit 135, the macro-information managing unit 136, the printer image drawing unit 151, the log control unit 152, the communication processing unit 155, the transferring unit 156, and the print processing unit 157 are generated on the main storage apparatus.

As described above, according to one aspect of the present invention, because a ticket is generated, with respect to each entity containing a single processing request and a series of processes to be executed based on the single processing request and log information is reduced and recorded with respect to each processing request indicated by the ticket, it is possible to store the log information with a reduced size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a log storing unit that stores therein log information as a history of events in the image forming apparatus;
a receiving unit that receives a predetermined processing request from a user;
a ticket generating unit that generates, for a processing request received from the user and an entity containing a series of processes to be executed based on the processing request, a ticket containing request identification information for identifying the processing request and user information for identifying the user;
an execution processing unit that executes, upon receiving the processing request and the ticket, requested processing according to the entity; and
a log managing unit that records first log information, which is the log information related to the processing executed by the execution processing unit, in the log storing unit in a reduced manner.

2. The image forming apparatus according to claim 1, further comprising:
an application unit that performs a process related to an image formation;
a hardware resource including the log storing unit; and
a platform unit that includes the log managing unit and the execution processing unit, and controls the hardware resource based on a request received from the application unit.

3. The image forming apparatus according to claim 2, wherein the first log information is security log information related to a security of the image forming apparatus.

4. The image forming apparatus according to claim 3, wherein the log managing unit records the security log information in the storing unit for each processing request indicated by the ticket by excluding redundant contents in the processing request.

5. The image forming apparatus according to claim 4, wherein the log managing unit records the security log information in the storing unit for each processing request indicated by the ticket by recording all contents of the security log in the log storing unit at a first recording and excluding redundant contents at a second or later recording in the processing request.

6. The image forming apparatus according to claim 3, wherein the log managing unit records access counts to desired information exclusively as the security log in the log storing unit in the processing request for each processing request indicated by the ticket.

7. The image forming apparatus according to claim 3, wherein
the receiving unit further receives a setting of a recording pattern defining a log item to be excluded at a time of recording the security log for each type of an operation target an operation type of the operation target, and
the log managing unit the log managing unit records the security log information in the storing unit for each processing request indicated by the ticket by excluding recording of the item based on set recording pattern in the processing request.

8. The image forming apparatus according to claim 7, wherein
the receiving unit further receives a setting of an attribute to be added to the security log at the time of recording the security log for each type of the operation target, and
the log managing unit records the security log with the attribute added in the log storing unit.

9. The image forming apparatus according to claim 1, further comprising:
an application unit that performs a process related to an image formation;
a hardware resource including the log storing unit; and
a platform unit including the log managing unit and the execution processing unit, and controls the hardware resource based on a request received from the application unit, wherein
the log storing unit further stores therein second log information that is a history of output information of output data and a number of output sheets,
the application unit includes
an output unit that outputs the output data,
a log recording unit that records the second log information in the log storing unit for each output job corresponding to the processing request indicated by the ticket, and
an output-information determining unit that determines whether output information identical to new output information that is obtained when the output unit outputs the output data is contained in the second log information stored in the log storing unit, and
the log recording unit updates, when the output-information determining unit determines that the output information identical to the new output information is contained in the second log information, the number of output sheets by increasing the number of output sheets contained in the output information that is identical to the new output information and stored in the log storing unit, without recording the new output information as the second log information in the log storing unit.

10. The image forming apparatus according to claim 9, wherein the log recording unit records, when the output-information determining unit determines that the output information identical to the new output information is not contained in the second log information, the new output information as the second log information in the log storing unit.

11. The image forming apparatus according to claim 10, wherein
the image forming apparatus is connected to a log collecting apparatus via a network, and
the application unit further includes a transferring unit that transfers the second log information stored in the log storing unit to the log collecting apparatus.

12. The image forming apparatus according to claim 11, wherein the log recording unit deletes the second log information transferred to the log collecting apparatus from the log storing unit when a predetermined time has elapsed after transferring the second log information to the log collecting apparatus.

13. A log storing method in an image forming apparatus including a log storing unit that stores therein log information as a history of events in the image forming apparatus, the log storing method comprising:
receiving a predetermined processing request from a user;
generating, for a processing request received from the user and an entity containing a series of processes to be executed based on the processing request, a ticket containing request identification information for identifying the processing request and user information for identifying the user;
executing, upon receiving the processing request and the ticket, requested processing according to the entity; and
recording log information related to the processing executed at the executing in the log storing unit in a reduced manner.

14. A computer program product comprising a computer-usable medium having computer-readable program codes embodied in the medium for storing a log in an image forming apparatus including a log storing unit that stores therein log information as a history of events in the image forming apparatus, the program codes when executed causing a computer to execute:
receiving a predetermined processing request from a user;
generating, for a processing request received from the user and an entity containing a series of processes to be executed based on the processing request, a ticket containing request identification information for identifying the processing request and user information for identifying the user;
executing, upon receiving the processing request and the ticket, requested processing according to the entity; and
recording log information related to the processing executed at the executing in the log storing unit in a reduced manner.
